(19) United States
(12) Patent Application Publication
(10) Pub. No.: US 2017/0033455 A1
(43) Pub. Date: Feb. 2, 2017

(54) Active Interference Avoidance in Unlicensed Bands

(71) Applicant: Google Inc., Mountain View, CA (US)

(72) Inventors: Paul James Husted, San Jose, CA (US); David James Weber, San Carlos, CA (US); Arnold R. Feldman, San Francisco, CA (US)

(73) Assignee: Google Inc., Mountain View, CA (US)

(21) Appl. No.: 14/809,588

(22) Filed: Jul. 27, 2015

(51) Int. Cl. H01Q 3/22; H01Q 3/24; H01Q 3/02

(52) U.S. Cl. CPC H01Q 3/22; H01Q 3/02; H01Q 3/24; H01Q 3/247

(57) ABSTRACT

A method for active interference avoidance in unlicensed bands. The method includes receiving an electromagnetic signal having a transmission frequency, a transmission period, and an antenna pattern from a phased array antenna. The method also includes switching the transmission frequency from a first transmission frequency with a first signal to interference and noise ratio to a second transmission frequency with a second signal to interference and noise ratio, wherein the second signal to interference and noise ratio is lower than the first signal to interference and noise ratio. The method further includes selecting a transmission period based on a time when a least amount of signal noise is present on the transmission frequency and selecting an antenna pattern that reduces interference on the selected transmission frequency.

### TECHNICAL FIELD

This disclosure relates to active interference avoidance.

### BACKGROUND

A communication network is a large distributed system for receiving information (e.g., a signal) and transmitting the information to a destination. Over the past few decades the demand for communication access has dramatically increased. Although conventional wire and fiber landlines, cellular networks, and geostationary satellite systems have continuously been increasing to accommodate the growth in demand, the existing communication infrastructure is still not large enough to accommodate the increase in demand. In addition, some areas of the world are not connected to a communication network and therefore cannot be part of the global community where everything is connected to the internet.

Satellites are used to provide communication services to areas where wired cables cannot reach. Satellites may be geostationary or non-geostationary. Geostationary satellites remain permanently in the same area of the sky as viewed from a specific location on earth, because the satellite is orbiting the equator with an orbital period of exactly one day. Non-geostationary satellites typically operate in low- or mid-earth orbit, and do not remain stationary relative to a fixed point on earth; the orbital path of a satellite can be described in part by the plane intersecting the center of the earth and containing the orbit. Each satellite may be equipped with communication devices called inter-satellite links (or, more generally, inter-device links) to communicate with other satellites in the same plane or in other planes. The communication devices allow the satellites to communicate with other satellites. These communication devices are expensive and heavy. In addition, the communication devices significantly increase the cost of building, launching and operating each satellite; they also greatly complicate the design and development of the satellite communication system and associated antennas and mechanisms to allow each satellite to acquire and track other satellites whose relative position is changing. Each antenna has a mechanical or electronic steering mechanism, which adds weight, cost, vibration, and complexity to the satellite, and increases risk of failure. Requirements for such tracking mechanisms are much more challenging for inter-satellite links designed to communicate with satellites in different planes than for links, which only communicate with nearby satellites in the same plane, since there is much less variation in relative position. Similar considerations and added cost apply to high-altitude communication balloon systems with inter-balloon links.

### SUMMARY

One aspect of the disclosure provides a method for active interference avoidance in unlicensed bands. The method includes receiving an electromagnetic signal having a transmission frequency, a transmission period, and an antenna pattern at a phased array antenna. The method also includes switching the transmission frequency from a first transmission frequency with a first signal to interference and noise ratio to a second transmission frequency with a second signal to interference and noise ratio, wherein the second signal to interference and noise ratio is lower than the first signal to interference and noise ratio. The method further includes selecting a transmission period based on a time when a least amount of signal noise is present on the transmission frequency and selecting an antenna pattern that reduces interference on the selected transmission frequency.

Implementations of the disclosure may include one or more of the following optional features. In some implementations, the method includes stopping the transmission for a temporary period of time and measuring a signal to interference and noise ratio of possible transmission frequencies. The method also includes receiving a desired transmission frequency from a transmission monitoring device and switching the transmission frequency to the desired transmission frequency. The transmission monitoring device is a wireless router. The method may further include receiving a target transmission period from a transmission monitoring device and adjusting the transmission period to the target transmission period.

In some examples, the method includes selecting an antenna pattern based on a number of packet errors. The method may also include adjusting the antenna pattern based on a table of antenna patterns, measuring an amount of interference of the electromagnetic signal for each of the antenna patterns from the table of antenna patterns, and selecting the antenna pattern wherein the electromagnetic signal has a least amount of interference.

In some implementations, the method includes adjusting a position of the phased array antenna from a first position to a second position, measuring an amount of interference of the electromagnetic signal in the first position and the second position, selecting the position having a least amount of interference of the electromagnetic signal between the first position and the second position, and moving the phased array antenna to the selected position. The phased array antenna may include a plurality of antennas, and the method may further include measuring a first amount of interference on the electromagnetic signal, selecting a test antenna of the plurality of antennas, disabling the test antenna, measuring a second amount of interference on the electromagnetic signal, and enabling the test antenna when the first amount of interference of the electromagnetic signal is less than or equal to the second amount of interference. In some examples, the method includes measuring a first amount of interference on the electromagnetic signal, selecting a filter bank, connecting the filter bank to the phased array antenna, measuring a second amount of interference on the electromagnetic signal, and disconnecting the filter bank when the first amount of interference is lower than the second amount of interference.

Another aspect of the disclosure provides a phased array antenna system. The phased array antenna includes a plurality of antenna configured to receive an electromagnetic signal having a signal frequency, a signal transmission period, a signal shape, and a signal interference. A frequency controller is connected to the phased array antenna and is configured to adjust the signal frequency of the electromagnetic signal based on the signal interference. A period controller is connected to the phased array antenna and is configured to adjust the signal transmission period of the electromagnetic signal to minimize the signal interference. A shape controller is connected to the phased array antenna and is configured to adjust the signal shape of the electromagnetic signal by selecting a taper from a collection of preset tapers.

This aspect may include one or more of the following optional features. The shape controller may be configured to select the taper based on an amount of interference of the electromagnetic signal. The shape controller may further be configured to select the taper based on a lost packet value. The frequency controller may be configured to adjust the signal frequency based on an interference measurement received from a user terminal in communication with the frequency controller.

In some examples, the phased array antenna further includes a filter bank controller connected to the phased array antenna and a plurality of filter banks connected to the filter bank controller and configured to filter the electromagnetic signal. The filter bank may be configured to activate a filter bank of the plurality of filter banks to filter the electromagnetic signal based on the signal interference. The phased array antenna may further include an antenna switch connected to at least one antenna of the plurality of antennas, wherein the antenna switch is configured to disconnect the at least one antenna in response to the signal interference.

In some implementations, the period controller is configured to adjust the signal transmission period of the electromagnetic signal based on a time interference value received from a user terminal in communication with the period controller. The phased array antenna may also include a rotator connected to the phased array antenna and a position controller connected to the rotator and configured to control the rotator to adjust a position of the phased array antenna in response to the signal interference. The shape controller may select the taper from the collection of preset tapers on the signal interference.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1A is a schematic view of an exemplary communication system.

FIG. 1B is a schematic view of an exemplary global-scale communication system with satellites and communication balloons, where the satellites form a polar constellation.

FIG. 1C is a schematic view of an exemplary group of satellites of FIG. 1A forming a Walker constellation.

FIGS. 2A and 2B are perspective views of example high-altitude platforms.

FIG. 3 is a perspective view of an example satellite.

FIG. 4A is a schematic view of an exemplary communication system that includes a high altitude platform and a ground terminal.

FIG. 4B is a schematic view of an exemplary communication system that includes a phased antenna array and end users.

FIG. 5A is a schematic view of an exemplary phased array antenna.

FIG. 5B is a schematic view of an exemplary phased array antenna including a transmission monitoring device.

FIG. 5C is a schematic view of an exemplary phased array antenna including a user terminal and table of reception beam patterns.

FIG. 5D is a schematic view of an exemplary phased array antenna including a filter bank and filter bank controller.

FIG. 5E is a schematic view of an exemplary phased array antenna including an antenna switch, a rotator and a position controller.

FIG. 6 is a schematic view of a method for operating a phased array antenna to avoid interference.

Like reference symbols in the various drawings indicate like elements.

### DETAILED DESCRIPTION

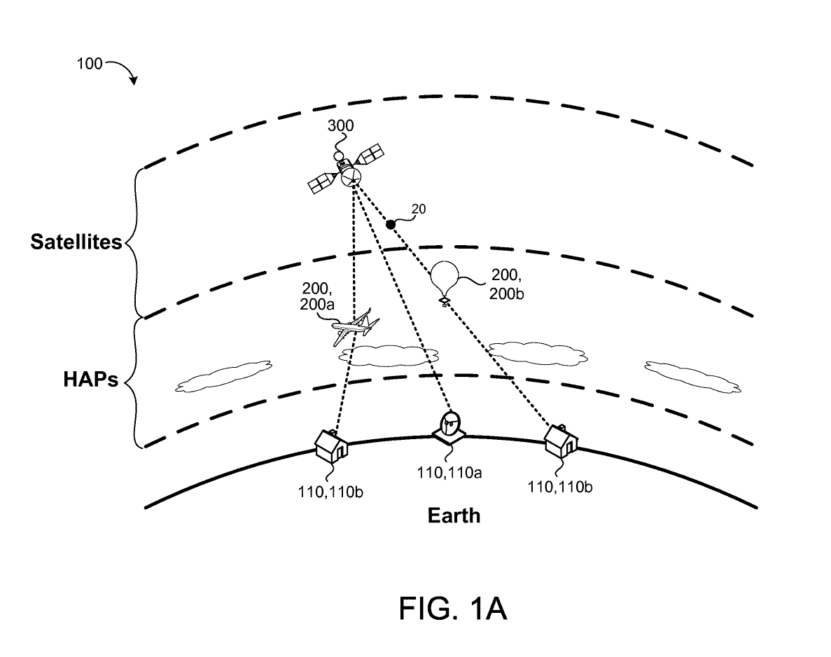

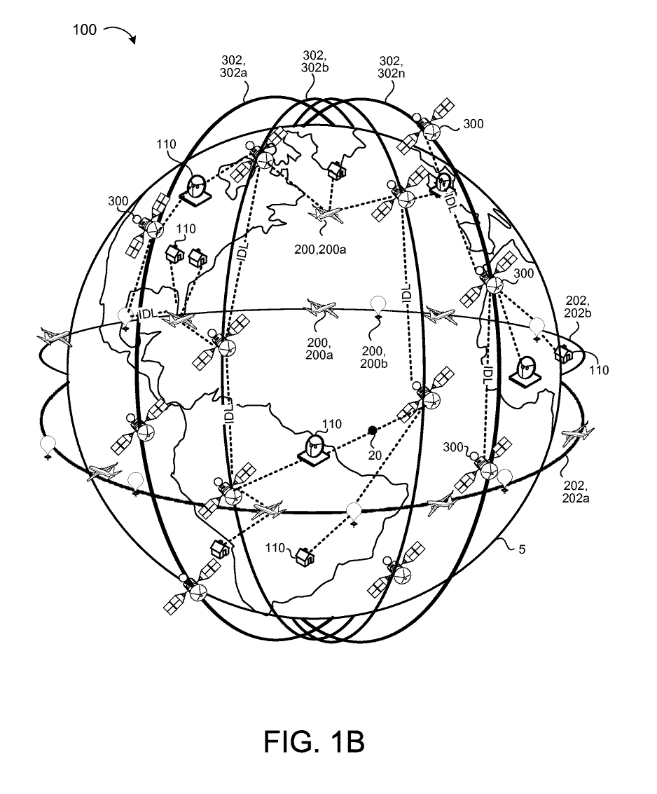

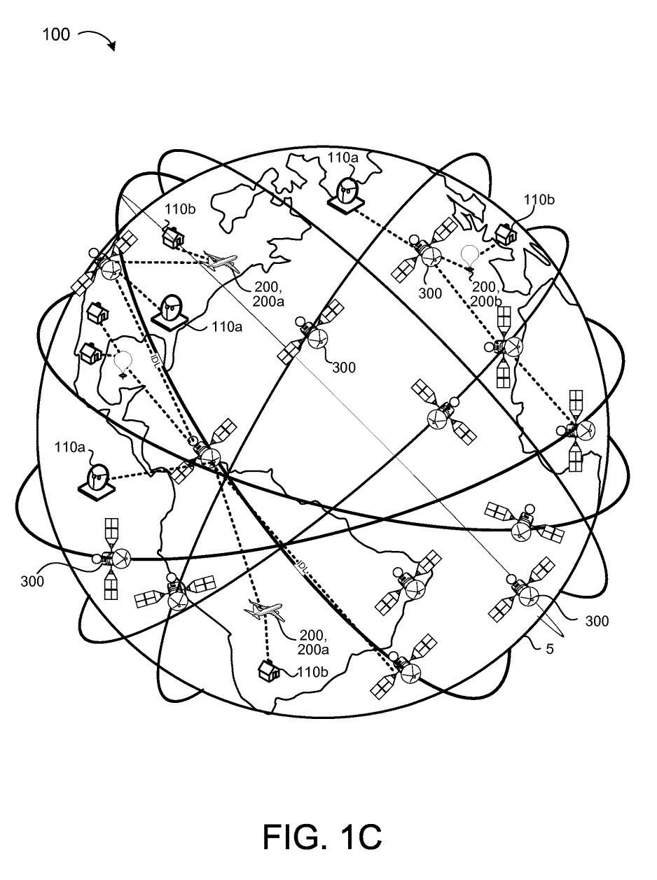

Referring to FIGS. 1A-1C, in some implementations, a global-scale communication system 100 includes gateways 110 (e.g., source ground stations 110a and destination ground stations 110b), high altitude platforms (HAPs) 200, and satellites 300. The source ground stations 110a may communicate with the satellites 300, the satellites 300 may communicate with the HAPs 200, and the HAPs 200 may communicate with the destination ground stations 110b. In some examples, the source ground stations 110a also operate as linking-gateways between satellites 300. The source ground stations 110a may be connected to one or more service providers and the destination ground stations 110b may be user terminals (e.g., mobile devices, residential WiFi devices, home networks, etc.). In some implementations, a HAP 200 is an aerial communication device that operates at high altitudes (e.g., 17-22 km). The HAP may be released into the earth's atmosphere, e.g., by an air craft, or flown to the desired height. Moreover, the HAP 200 may operate as a quasi-stationary aircraft. In some examples, the HAP 200 is an aircraft 200a, such as an unmanned aerial vehicle (UAV); while in other examples, the HAP 200 is a communication balloon 200b. The satellite 300 may be in Low Earth Orbit (LEO), Medium Earth Orbit (MEO), or High Earth Orbit (HEO), including Geosynchronous Earth Orbit (GEO).

The HAPs 200 may move about the earth 5 along a path, trajectory, or orbit 202 (also referred to as a plane, since their orbit or trajectory may approximately form a geometric plane). Moreover, several HAPs 200 may operate in the same or different orbits 202. For example, some HAPs 200 may move approximately along a latitude of the earth 5 (or in a trajectory determined in part by prevailing winds) in a first orbit 202a, while other HAPs 200 may move along a different latitude or trajectory in a second orbit 202b. The HAPs 200 may be grouped amongst several different orbits 202 about the earth 5 and/or they may move along other paths 202 (e.g., individual paths). Similarly, the satellites 300 may move along different orbits 302, 302a-n. Multiple satellites 300 working in concert form a satellite constellation. The satellites 300 within the satellite constellation may operate in a coordinated fashion to overlap in ground coverage. In the example shown in FIG. 1B, the satellites 300 operate in a polar constellation by having the satellites 300 orbit the poles of the earth 5; whereas, in the example shown in FIG. 1C, the satellites 300 operate in a Walker constellation, which covers areas below certain latitudes and provides a larger number of satellites 300 simultaneously in view of a gateway 110 on the ground (leading to higher availability, fewer dropped connections).

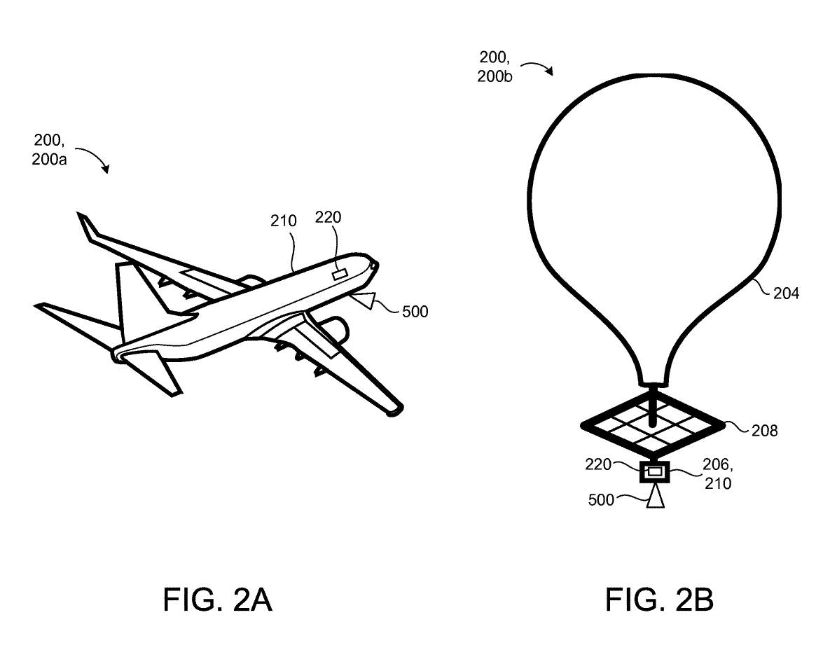

Referring to FIGS. 2A and 2B, in some implementations, the HAP 200 includes a HAP body 210 and an antenna 500 disposed on the HAP body 210 that receives a communication 20 from a satellite 300 and reroutes the communication 20 to a destination ground station 110b and vice versa. The HAP 200 may include a data processing device 220 that processes the received communication 20 and determines a path of the communication 20 to arrive at the destination ground station 110b (e.g., user terminal). In some implementations, user terminals 110b on the ground have specialized antennas that send communication signals to the HAPs 200. The HAP 200 receiving the communication 20 sends the communication 20 to another HAP 200, to a satellite 300, or to a gateway 110 (e.g., a user terminal 110b).

FIG. 2B illustrates an example communication balloon 200b that includes a balloon 204 (e.g., sized about 49 feet in width and 39 feet in height and filled with helium or hydrogen), an equipment box 206 as a HAP body 210, and solar panels 208. The equipment box 206 includes a data processing device 310 that executes algorithms to determine where the high-altitude balloon 200a needs to go, then each high-altitude balloon 200b moves into a layer of wind blowing in a direction that will take it where it should be going. The equipment box 206 also includes batteries to store power and a transceiver (e.g., antennas 500) to communicate with other devices (e.g., other HAPs 200, satellites 300, gateways 110, such as user terminals 110b, internet antennas on the ground, etc.). The solar panels 208 may power the equipment box 206.

Communication balloons 200a are typically released in to the earth's stratosphere to attain an altitude between 11 to 23 miles and provide connectivity for a ground area of 25 miles in diameter at speeds comparable to terrestrial wireless data services (such as, 3G or 4G). The communication balloons 200a float in the stratosphere at an altitude twice as high as airplanes and the weather (e.g., 20 km above the earth's surface). The high-altitude balloons 200a are carried around the earth 5 by winds and can be steered by rising or descending to an altitude with winds moving in the desired direction. Winds in the stratosphere are usually steady and move slowly at about 5 and 20 mph, and each layer of wind varies in direction and magnitude.

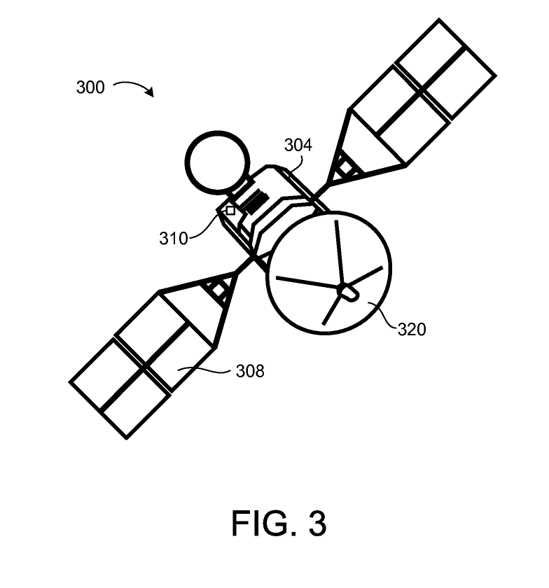

Referring to FIG. 3, a satellite 300 is an object placed into orbit 302 around the earth 5 and may serve different purposes, such as military or civilian observation satellites, communication satellites, navigations satellites, weather satellites, and research satellites. The orbit 302 of the satellite 300 varies depending in part on the purpose of the satellite 200b. Satellite orbits 302 may be classified based on their altitude from the surface of the earth 5 as Low Earth Orbit (LEO), Medium Earth Orbit (MEO), and High Earth Orbit (HEO). LEO is a geocentric orbit (i.e., orbiting around the earth 5) that ranges in altitude from 0 to 1,240 miles. MEO is also a geocentric orbit that ranges in altitude from 1,200 miles to 22,236 miles. HEO is also a geocentric orbit and has an altitude above 22,236 miles. Geosynchronous Earth Orbit (GEO) is a special case of HEO. Geostationary Earth Orbit (GSO, although sometimes also called GEO) is a special case of Geosynchronous Earth Orbit.

In some implementations, a satellite 300 includes a satellite body 304 having a data processing device 310, e.g., similar to the data processing device 310 of the HAPs 200. The data processing device 310 executes algorithms to determine where the satellite 300 is heading. The satellite 300 also includes an antenna 320 for receiving and transmitting a communication 20. The satellite 300 includes solar panels 308 mounted on the satellite body 204 for providing power to the satellite 300. In some examples, the satellite 300 includes rechargeable batteries used when sunlight is not reaching and charging the solar panels 308.

When constructing a global-scale communications system 100 using HAPs 200, it is sometimes desirable to route traffic over long distances system 100 by linking HAPs 200 to satellites 300 and/or one HAP 200 to another. For example, two satellites 300 may communicate via inter-device links and two HAPs 200 may communicate via inter-device links. Inter-device link (IDL) eliminates or reduces the number of HAPs 200 or satellites 300 to gateway 110 hops, which decreases the latency and increases the overall network capabilities. Inter-device links allow for communication traffic from one HAP 200 or satellite 300 covering a particular region to be seamlessly handed over to another HAP 200 or satellite 300 covering the same region, where a first HAP 200 or satellite 300 is leaving the first area and a second HAP 200 or satellite 300 is entering the area. Such inter-device linking is useful to provide communication services to areas far from source and destination ground stations 110a, 110b and may also reduce latency and enhance security (fiber optic cables 12 may be intercepted and data going through the cable may be retrieved). This type of inter-device communication is different than the “bent-pipe” model, in which all the signal traffic goes from a source ground station 110a to a satellite 300, and then directly down to a destination ground station 110b (e.g., user terminal) or vice versa. The “bent-pipe” model does not include any inter-device communications. Instead, the satellite 300 acts as a repeater. In some examples of “bent-pipe” models, the signal received by the satellite 300 is amplified before it is retransmitted; however, no signal processing occurs. In other examples of the “bent-pipe” model, part or all of the signal may be processed and decoded to allow for one or more of routing to different beams, error correction, or quality-of-service control; however no inter-device communication occurs.

In some implementations, large-scale communication constellations are described in terms of a number of orbits 202, 302, and the number of HAPs 200 or satellites 300 per orbit 202, 302. HAPs 200 or satellites 300 within the same orbit 202, 302 maintain the same position relative to their intra-orbit HAP 200 or satellite 300 neighbors. However, the position of a HAP 200 or a satellite 300 relative to neighbors in an adjacent orbit 202, 302 may vary over time. For example, in a large-scale satellite constellation with near-polar orbits, satellites 300 within the same orbit 202 (which corresponds roughly to a specific latitude, at a given point in time) maintain a roughly constant position relative to their intra-orbit neighbors (i.e., a forward and a rearward satellite 300), but their position relative to neighbors in an adjacent orbit 302 varies over time. A similar concept applies to the HAPs 200; however, the HAPs 200 move about the earth 5 along a latitudinal plane and maintain roughly a constant position to a neighboring HAP 200.

A source ground station 110a may be used as a connector between satellites 300 and the internet, or between HAPs 200 and user terminals 110b. In some examples, the system 100 utilizes the source ground station 110a as linking-gateways 110a for relaying a communication 20 from one HAP 200 or satellite 300 to another HAP 200 or satellite 300, where each HAP 200 or satellite 300 is in a different orbit 202, 302. For example, the linking-gateway 110a may receive a communication 20 from an orbiting satellite 300, process the communication 20, and switch the communication 20 to another satellite 300 in a different orbit 302. Therefore, the combination of the satellites 300 and the linking-gateways 110a provide a fully-connected system 100. For the purposes of further examples, the gateways 110 (e.g., source ground stations 110a and destination ground stations 110b), shall be referred to as ground stations 110.

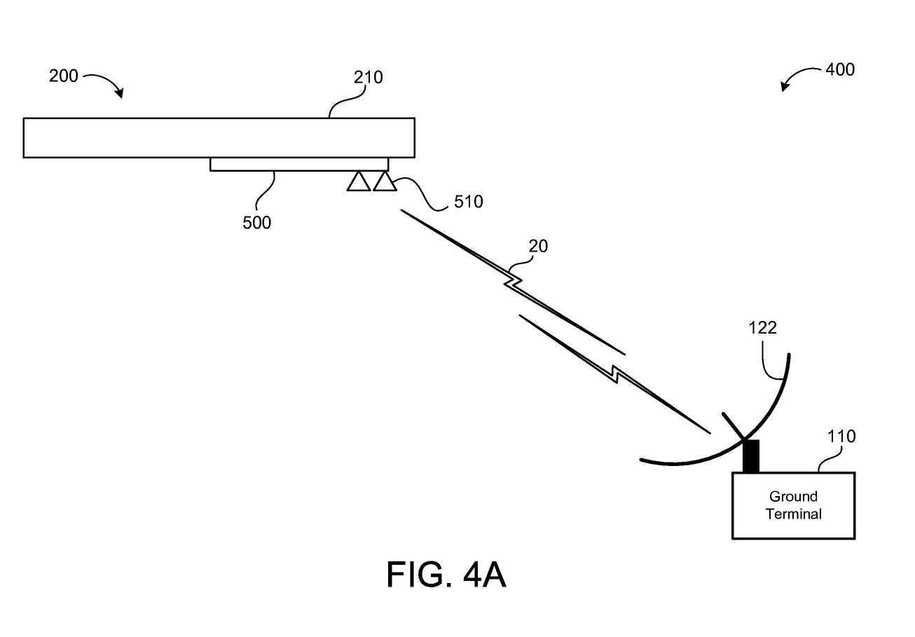

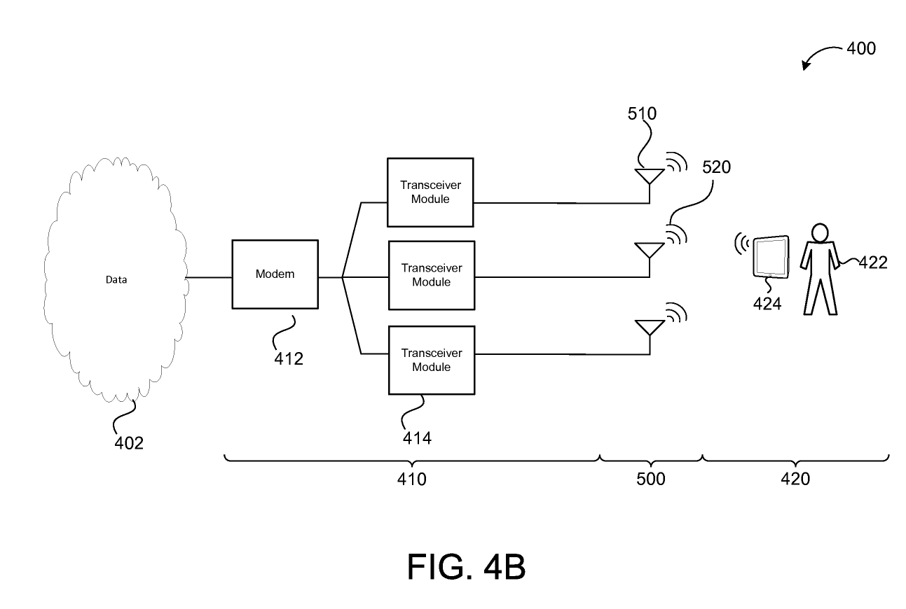

FIG. 4A provides a schematic view of an exemplary architecture of a communication system 400 establishing a communications link between a HAP 200 and a ground station 110 (e.g., a gateway 110). In some examples, the HAP 200 is an unmanned aerial system (UAS). The two terms are used interchangeably throughout this application. In the example shown, the HAP 200 includes a body 210 that supports a phased array antenna 500, which can communicate with the ground station 110 through a communication 20 (e.g., radio signals or electromagnetic energy). The ground station 110 includes a ground antenna 122 designed to communicate with the HAP 200. The HAP 200 may communicate various data and information to the ground station 110, such as, but not limited to, airspeed, heading, attitude position, temperature, GPS (global positioning system) coordinates, wind conditions, flight plan information, fuel quantity, battery quantity, data received from other sources, data received from other antennas, sensor data, etc. The ground station 110 may communicate to the HAP 200 various data and information, such as, but not limited to, flight directions, flight condition warnings, control inputs, requests for information, requests for sensor data, data to be retransmitted via other antennas or systems, etc. The HAP 200 may be various implementations of flying craft including a combination of the following such as, but not limited to an airplane, airship, helicopter, gyrocopter, blimp, multi-copter, glider, balloon, fixed wing, rotary wing, rotor aircraft, lifting body, heavier than air craft, lighter than air craft, etc.

One of the challenges associated with establishing a communication system between a HAP 200 and ground station 110 is the movement and distance of the HAP 200. One solution to this problem is the use of an omnidirectional antenna system on the HAP 200 and ground station 110. This presents disadvantages as an omnidirectional antenna has a lower gain and therefore range is exchanged for its ability to receive from all directions. Additionally, the large reception area makes it more susceptible to interference. A directional antenna may be used to improve the gain, range, and interference rejection of the system, but this presents its own challenges as depending on how directional the antenna is, the craft may move out of the antennas transmission or reception area. When using a directional antenna, a system needs to move both of the antennas (i.e., the HAP antenna and the ground terminal antenna) to keep the antennas aligned between the aircraft and the ground. The lower the general amount interference of the signal the less directional the antenna may be, allowing for easier communications. The greater directionality of the antenna required to overcome the interference and cover the distance required, the more precise the antenna following system must be. Even a highly direction antenna will not serve to reject all forms of interference. In combination with the distances that the HAP 200 is operating at, there are significant challenges associated with signal strength and interference. This disclosure presents a phased array antenna 500 having a combination of interference avoidance systems to allow for continuous coverage of a link to a fixed ground station 110.

In radio transmission systems, an array of antennas can be used to increase the ability to communicate at greater range and/or increase antenna gain in a direction over individual elements. In a phased array antenna, the phase of individual elements may be adjusted to shape the area of coverage results in longer transmissions, better reception or steering the transmission direction without physically moving the array. The shape of the coverage may be adjusted by the alteration of individual elements, transmission phase and/or gain in the array.

FIG. 4B provides a schematic view of an exemplary architecture of a communication system 400 including a phased array antenna 500 establishing a communications link between a HAP 200 and user terminals 420. A controller 410 receives data 402 and converts the data 402 into a form suitable for transmission to the phased array antenna 500. Contained within the controller 410 is a modem 412 and a transceiver module 414. The modem 412 converts the data 402 to a signal for transmission by the transceiver module 414 via electromagnetic energy or radio signals. The electromagnetic energy is then transmitted or received via a phased array antenna 500 composed of a plurality of antennas 510. The combination of signals from the antennas 510 forms an emission beam. The phased array antenna 500 transmits the data 402 in the form of electromagnetic energy over the air for receipt by the user terminal 420. The user terminal 420 may include independent devices 424 or personal devices 422. The system can also operate in the reverse order with the user terminal 420 transmitting a signal to the phased array antenna 500, which is then converted to data by the controller 410. The plurality of antenna 510 serve to act as different antenna shapes that can be reconfigured by adjusting the phase and gain of individual antenna 510 to optimize reception when receiving electromagnetic energy.

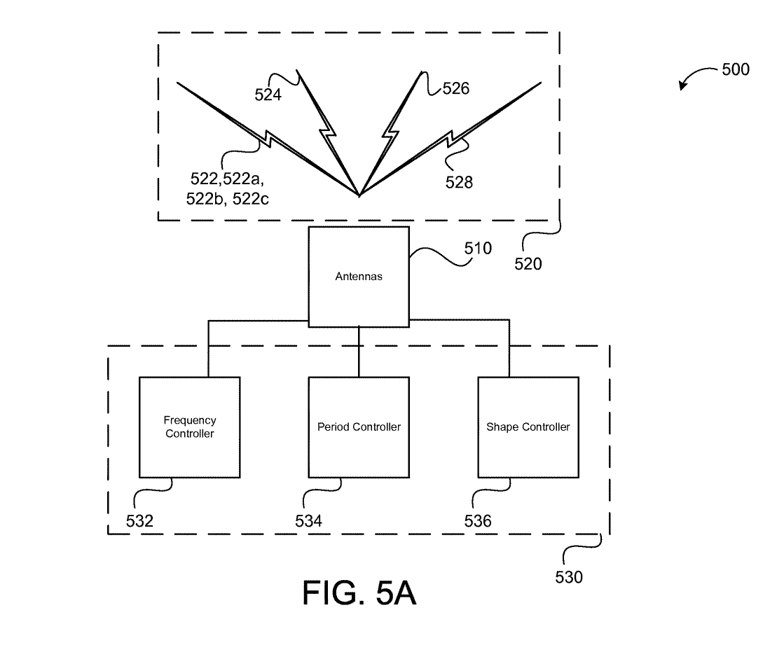

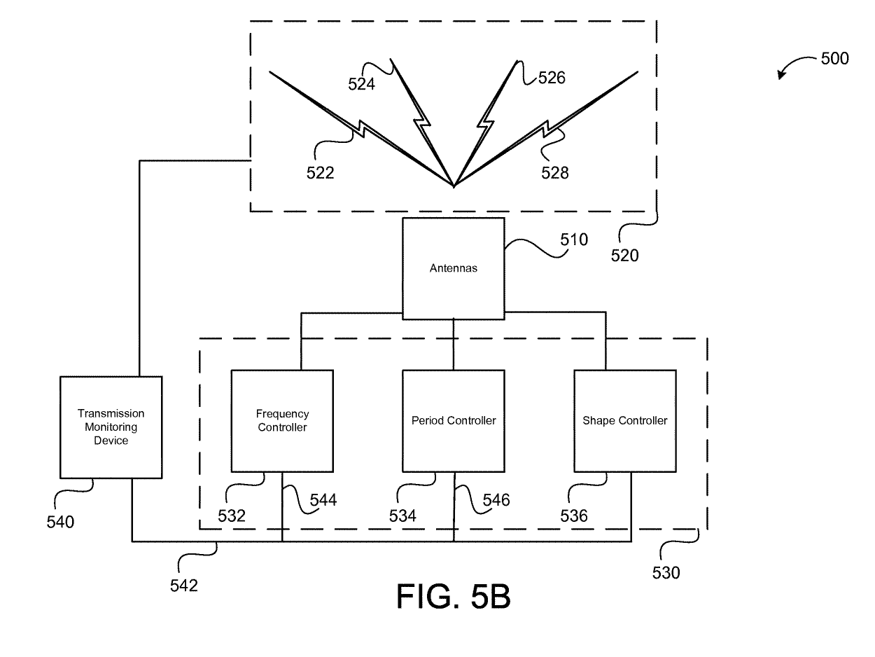

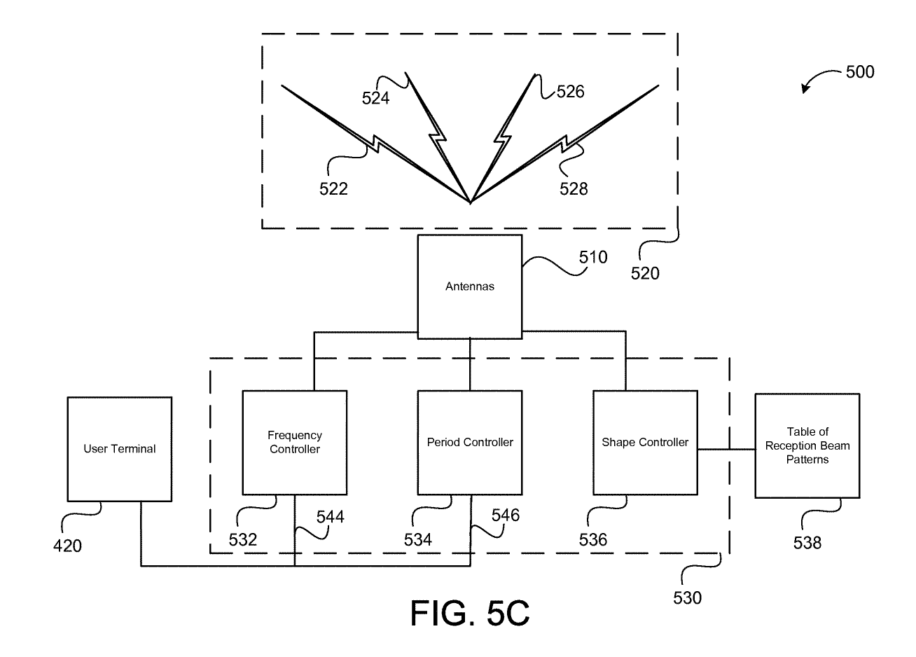

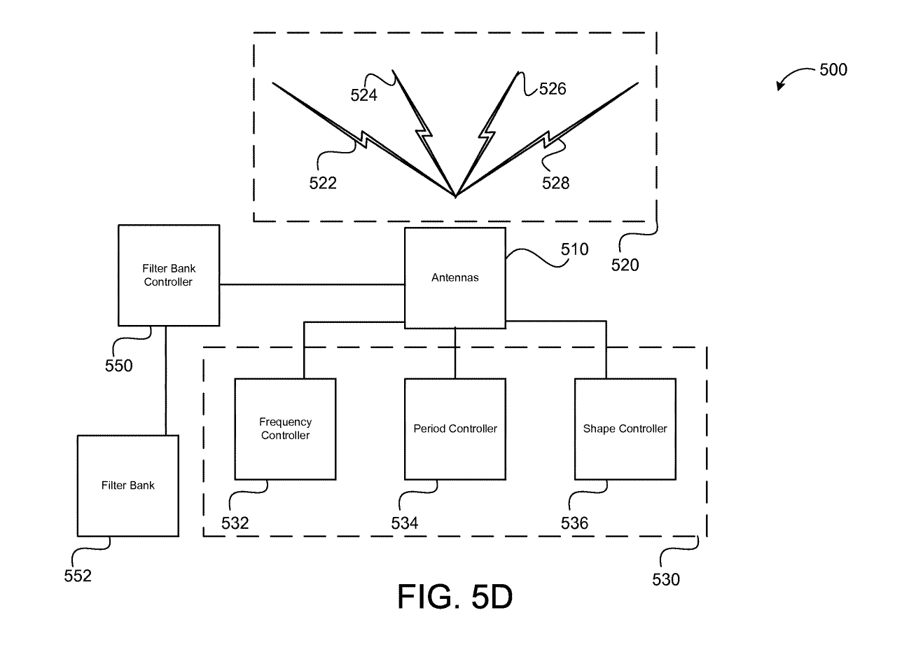

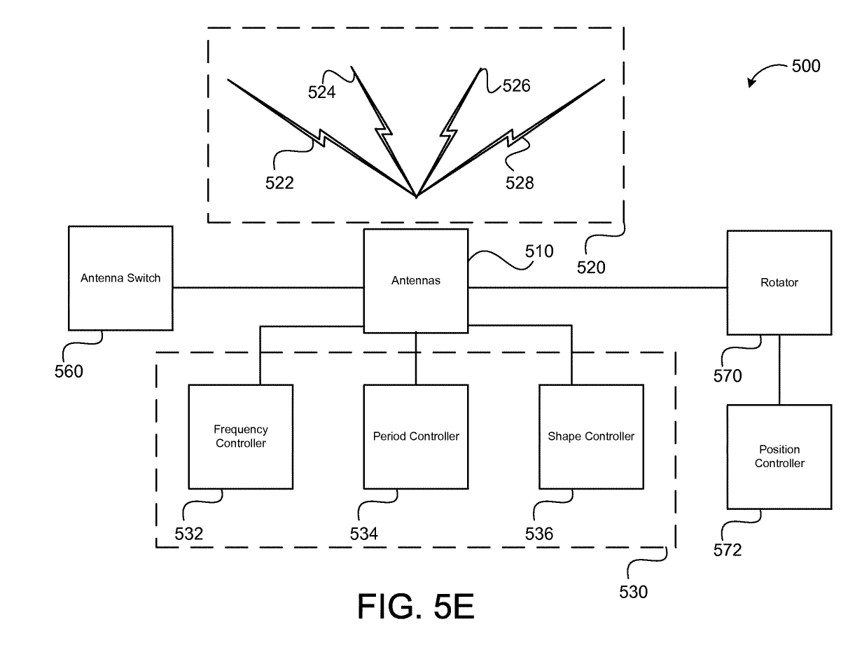

FIG. 5A provides a schematic view of an exemplary architecture of the phased array antenna 500. The antennas 510 emit or receive an electromagnetic signal 520. A signal frequency 522, a signal transmission period 524, a signal shape 526, and a signal interference 528 comprise the electromagnetic signal 520. The signal frequency 522 represents the rate at which the base signal or carrier wave occurs over a period of time. The signal frequency 522 may also be representative of the channel used within a given frequency band. The signal transmission period 524 represents the time during which the antennas 510 are transmitting or receiving. In some circumstances, the signal transmission period 524 may be continuous, a partial amount of time, or an unequal amount of time divided between transmitting and receiving. The signal shape 526 represents the shape or reception beam pattern of the electromagnetic signal 520. The signal shape 526 or reception beam pattern may be altered by changing the number of antenna 510 in operation, the signal frequency 522 of individual antennas 510, the placement of the antennas 510, individual antenna's 510 gain, or other means. In some examples, the signal shape 526 includes tapers or reception beam patterns, which are representative of given configurations of the number of antenna 510 in operation, the signal frequency 522 of individual antennas 510, and the placement of the antennas 510 to create a given signal shape 526 or reception beam pattern. The signal interference 528 represents the amount of interference, reception and transmission strength, received signal strength indicator, data packet loss and/or the signal to interference and noise. Signal interference 528 is a general description intended to cover all forms of measuring interference, such as, but not limited to signal to interference plus noise, signal interference plus noise ratio, signal to interference and noise ratio, signal noise ratio, peak signal to noise ratio, signal to noise and distortion ratio, etc.

A signal controller 530 controls the electromagnetic signal 520 emitted or received from the antennas 510. The signal controller 530 includes a frequency controller 532, a period controller 534, and a shape controller 536. The frequency controller 532 controls the signal frequency 522 and may switch the signal frequency 522 or reception or transmission in response to various information, such as the signal interference 528. In some examples, the frequency controller 532 examines the signal interference of a first signal frequency 522a. The frequency controller 532 may then switch the signal frequency 522 to a second signal frequency 522b and examine the signal interference 528. When the second signal frequency 522b has a higher signal interference 528, the frequency controller 532 may switch back to the first signal frequency 522a or to a third signal frequency 522c and repeat until the frequency controller 532 locates a suitable signal frequency 522 with an acceptable signal interference 528.

The period controller 534 controls the signal transmission period 524, adjusting the time period during which information is transmitted or received. The period controller 534 may wait for the signal interference 528 to decrease to an acceptable level and then transmit or receive information. In some examples, the period controller 534 may define a time period during which the antennas 510 transmit and receive data in response to the signal interference 528. In some examples, the period controller 534 ceases information transmission from the antennas 510 and measures the signal interference 528 for a period of time. The period controller 534 may direct other devices such as the HAP 200 to cease information transmission in order to measure the signal interference 528 or general interference of the environment for a period of time. Based on the signal interference 528 over the period of time, the period controller 534 may select a signal transmission period 524 corresponding with a value of a signal interference 528 below a given threshold.

The shape controller 536 controls the signal shape 526 or the reception beam pattern. The shape controller 536 may adjust all or individual frequencies, phases, and gains of the antennas 510, stop or start transmission of individual antennas 510, or may alter the position of individual antennas 510 in order to alter the signal shape 526 or reception beam pattern. Based on the signal interference 528, the shape controller 536 may alter the signal shape 526 or reception beam pattern to minimize the signal interference 528. In some examples, the signal shape 526 includes areas of signal nulls. A signal null represents an area where the antennas 510 are not receptive and therefore do not receive interference. The shape controller 536 may adjust the signal shape 526 or reception beam pattern to position the signal nulls in a manner to reduce the signal interference 528.

FIG. 5B provides a schematic view of an exemplary architecture of the phased array antenna 500. The phased array antenna 500 includes a transmission monitoring device 540. The transmission monitoring device 540 measures the signal interference 528 or the general interference of the electromagnetic spectrum. The transmission monitoring device 540 may be connected directly to the antennas 510 in order to measure the signal interference 528; it may have its own antenna 510 to measure the signal interference 528 or it may be remotely located in order to measure the signal interference 528. The transmission monitoring device 540 may communicate the signal interference 528 to the frequency controller 532, period controller 534, or the shape controller 536. Each of the frequency controller 532, period controller 534, or the shape controller 536 may make appropriate changes in order to reduce the signal interference 528, such as adjusting the signal frequency 522, signal transmission period 524, signal shape 526, or reception beam pattern, based on the information communicated from the transmission monitoring device 540. In some examples, the transmission monitoring device 540 communicates a desired transmission selection 542 to one or all of the frequency controller 532, period controller 534, or the shape controller 536 with a desired value for the signal frequency 522, signal transmission period 524, or signal shape 526 based on the measurement from the transmission monitoring device 540. The transmission monitoring device 540 may also communicate an interference measurement 544 of the general interference of the various electromagnetic spectrum to the frequency controller 532, period controller 534, or the shape controller 536, allowing the respective controller to make a selection to minimize the signal interference 528. The transmission monitoring device 540 may also communicate a time interference value 546 to the period controller 534 to coordinate the optimal signal transmission period 524 based on the signal interference 528. The transmission monitoring device 540 may also be a wireless router in communication with other nearby devices. The transmission monitoring device 540 wireless router and the period controller 534 may time each of their respective transmissions in order to minimize the signal interference 528 between the devices.

FIG. 5C provides a schematic view of an exemplary architecture of the phased array antenna 500. In some examples, the transmission monitoring device 540 is a user terminal 420, such as an independent device 424 or personal device 422. The user terminal 420 may communicate a desired transmission selection 542 to one or all of the frequency controller 532, period controller 534, or the shape controller 536 with a desired value for the signal frequency 522, signal transmission period 524, or signal shape 526 based on the measurement from the transmission monitoring device 540. The user terminal 420 may also communicate an interference measurement 544 of the general interference of the various electromagnetic spectrum to the frequency controller 532, period controller 534, or the shape controller 536 allowing the respective controller to make a selection to minimize the signal interference 528. The user terminal 420 may also transmit a time interference value 546 to the period controller 534 to coordinate the optimal signal transmission period 524 based on the signal interference 528. The user terminal 420 and the period controller 534 may time each of their respective transmissions or receptions in order to minimize the signal interference 528 by transmitting or receiving at a time of lowest signal interference 528.

In some examples, the shape controller 536 has access to a table of reception beam patterns 538 (e.g., lookup table, database, structured data set, etc.). The table of reception beam patterns 538 contains configurations of individual antennas 510, signal frequency, phase, transmission power, and/or positions of individual antennas 510 in order to alter the signal shape 526 or reception beam pattern. The shape controller 536 may cycle through the table of reception beam patterns 538 and select the one with the lowest signal interference 528.

FIG. 5D provides a schematic view of an exemplary architecture of the phased array antenna 500 including a filter bank controller 550 and a filter bank 552. The filter bank controller 550 is connected to the antennas 510 and measures the signal interference 528. The filter bank 552 is connected to the filter bank controller 550 and may be connected to the antenna 510. Depending on the signal interference 528, the filter bank controller 550 may select a filter from the filter bank 552 and connect it to the antennas 510. When the signal interference 528 is lower than without the filter connected or lower than a different filter, the filter bank controller 550 may leave the filter connected to the antenna 510. In some examples, the filter bank controller 550 connects multiple filters or no filters at all in order to minimize signal interference 528.

FIG. 5E provides a schematic view of an exemplary architecture of the phased array antenna 500 including an antenna switch 560, a rotator 570, and position controller 572. The antenna switch 560 may be connected to individual or groups of antennas 510. The antenna switch 560 detects the level of saturation of individual antennas 510 and the signal interference 528. In the event that an antenna 510 becomes saturated or subject to excessive signal interference 528, the signal switch may disconnect the antenna 510 from the group of antenna 510, stopping it from transmitting or receiving. This may serve to reduce the amount of signal interference 528 present on the system.

The rotator 570 is connected to the antennas 510 and configured to move a position of the antennas 510. In some examples, the rotator 570 includes a motor and a position sensor to physically move the antennas 510. The position controller 572 is connected to the rotator 570. The position controller 572 may read the signal interference 528 and move the position of the antennas 510 via the rotator 570 in order to minimize the signal interference 528. In some examples, the position controller 572 detects the location of the signal interference 528 and moves the antennas 510 to minimize the signal interference 528.

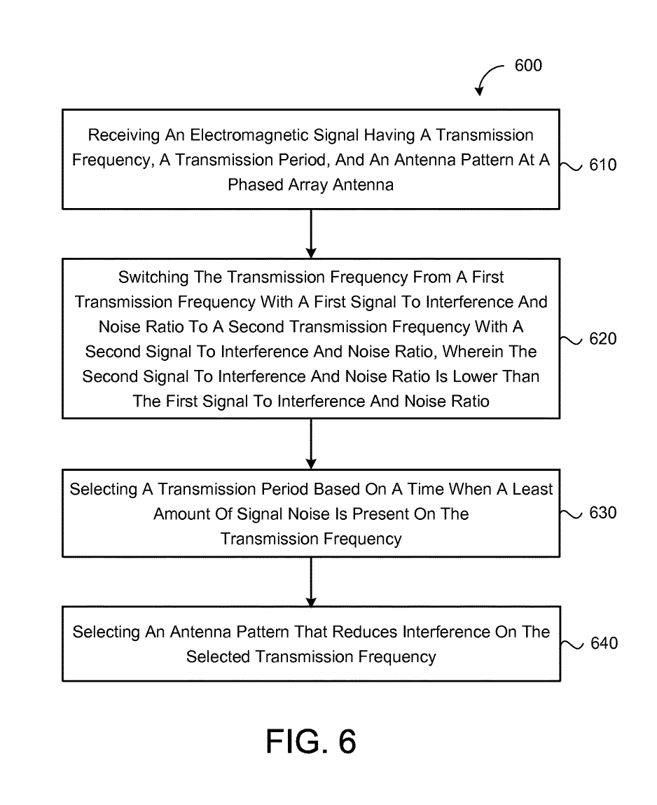

FIG. 6 illustrates a method 600 for operating a phased array antenna 500 to avoid interference. At block 610, the method 600 includes receiving an electromagnetic signal 520 having a transmission frequency 522, a signal transmission period 524, and an antenna pattern or signal shape 526 from a phased array antenna 500. The antennas 510 receive or emit an electromagnetic signal 520. A signal frequency 522, a signal transmission period 524, a signal shape 526, and a signal interference 528 comprise the electromagnetic signal 520. The signal frequency 522 represents the rate at which the base signal or carrier wave occurs over a period of time. The signal frequency 522 may also be representative of the channel used within a given frequency band. The signal transmission period 524 represents the time during which the antennas 510 are transmitting or receiving. In some circumstances the signal transmission period may be continuous, a partial amount of time, or an unequal amount of time divided between transmitting and receiving. The signal shape 526 represents the shape of the electromagnetic signal 520.

At block 620, the method 600 includes switching the transmission frequency or signal frequency 522 from a first transmission frequency or signal frequency 522 with a first signal to interference and noise ratio or signal interference 528 to a second transmission frequency or signal frequency 522 with a second signal to interference and noise ratio or signal interference 528, wherein the second signal to interference and noise ratio or signal interference 528 is lower than the first signal to interference and noise ratio or signal interference 528. The signal frequencies 522 may be switched from the first signal frequency 522 to the second signal frequency 522 by the frequency controller 532. The frequency controller 532 may read the signal interference 528 when the first signal frequency 522 or second signal frequency 522 is selected.

At block 630, the method 600 includes selecting a transmission period or signal transmission period 524 based on a time when a least amount of signal noise or signal interference 528 is present on the transmission frequency or signal frequency 522. The signal transmission period 524 may be controlled by a period controller 534. The period controller 534 may monitor the signal interference 528 for a time or repeating time period when the signal interference is minimal. The period controller 534 may then select a signal transmission period 524 that corresponds with the time when the signal interference 528 is minimal to minimize interference.

At block 640, the method 600 includes selecting an antenna pattern or signal shape 526 that reduces interference or signal interference 528 on the selected transmission frequency or signal frequency 522. The shape controller 536 may adjust all or individual antenna's 510 frequency, phase, stop or start transmission of individual antennas 510, or may alter the position of individual antennas 510 in order to alter the signal shape 526. The shape controller 536 may read the signal interference 528 and select a signal shape 526 that minimizes signal interference 528.

In some examples, the method 600 includes stopping the transmission or electromagnetic signal 520 for a temporary period of time and measuring a signal to interface and noise ratio or signal interference 528 of possible transmission frequencies or signal frequencies 522. The state of the electromagnetic spectrum can be measured during the period when there is no transmission of the electromagnetic signal 520 to determine the level of interference or signal interference 528 present on various signal frequencies 522. The step of receiving a desired transmission frequency or desired transmission selection 542 from a transmission monitoring device 540 may be included and switching the transmission frequency or signal frequency 522 to the desired transmission frequency or signal frequency 522. The transmission monitoring device 540 may be a wireless router. The method 600 may include receiving a target transmission period or time interference value 546 from a transmission monitoring device 540, adjusting the transmission period or signal transmission period 524 to the target transmission period or time interference value 546. An antenna pattern or signal shape 526 may be selected based on the number of packet errors.

In some examples, the method 600 includes adjusting the antenna pattern or signal shape 526 based on a table of antenna patterns or table of reception beam patterns 538. The method also includes measuring an amount of interference or signal interference 528 of the electromagnetic signal 520 for each of the antenna patterns or signal shape 526 from the table of antenna patterns or table of reception beam patterns 538 and selecting the antenna pattern or signal shape 526, wherein the electromagnetic signal 520 has a least amount of interference or signal interference 528. The method 600 may further include adjusting a position of the phased array antenna 500 from a first position to a second position, measuring an amount of interference or signal interference 528 of the electromagnetic signal 520 in the first position and the second position, selecting the position having a least amount of interference or signal interference 528 of the electromagnetic signal 520 between the first position and the second position, and moving the phased array antenna 500 to the selected position.

In at least one example, the phased array antenna 500 further includes a plurality of antennas. The method 600 may further include measuring a first amount of interference or signal interference 528 on the electromagnetic signal 520, selecting a test antenna 510 of the plurality of antennas 510, disabling the test antenna 510, measuring a second amount of interference or signal interference 528 on the electromagnetic signal 520, and enabling the test antenna 510 when the first amount of interference or signal interference 528 of the electromagnetic signal 520 is less than or equal to the second amount of interference or signal interference 528. In some examples, the method 600 includes measuring a first amount of interference or signal interference 528 on the electromagnetic signal 520, selecting a filter bank 552, connecting the filter bank 552 to the phased array antenna 500, measuring a second amount of interference or signal interference 528 on the electromagnetic signal 520, and disconnecting the filter bank 552 when the first amount of interference or signal interference 528 is lower than the second amount of interference or signal interference 528.

A number of implementations have been described. Nevertheless, it will be understood that various modifications may be made without departing from the spirit and scope of the disclosure. Accordingly, other implementations are within the scope of the following claims. For example, the actions recited in the claims can be performed in a different order and still achieve desirable results.

What is claimed is:

1. A method comprising:
receiving an electromagnetic signal having a transmission frequency, a transmission period, and an antenna pattern at a phased array antenna;
switching the transmission frequency from a first transmission frequency with a first signal to interference and noise ratio to a second transmission frequency with a second signal to interference and noise ratio, wherein the second signal to interference and noise ratio is lower than the first signal to interference and noise ratio;
selecting a transmission period based on a time when a least amount of signal noise is present on the transmission frequency; and
selecting an antenna pattern that reduces interference on the selected transmission frequency.

2. The method of claim 1, further comprising:
stopping the transmission for a temporary period of time; and
measuring a signal interface noise ratio of possible transmission frequencies.

3. The method of claim 1, further comprising:
receiving a desired transmission frequency from a transmission monitoring device; and
switching the transmission frequency to the desired transmission frequency.

4. The method of claim 3, wherein the transmission monitoring device is a wireless router.

5. The method of claim 1, further comprising:
receiving a target transmission period from a transmission monitoring device; and
adjusting the transmission period to the target transmission period.

6. The method of claim 1, further comprising selecting an antenna pattern based on a number of packet errors.

7. The method of claim 1, further comprising:
adjusting the antenna pattern based on a table of antenna patterns;
measuring an amount of interference of the electromagnetic signal for each of the antenna patterns from the table of antenna patterns; and
selecting the antenna pattern wherein the electromagnetic signal has a least amount of interference.

8. The method of claim 1, further comprising:
adjusting a position of the phased array antenna from a first position to a second position;
measuring an amount of interference of the electromagnetic signal in the first position and the second position;
selecting the position having a least amount of interference of the electromagnetic signal between the first position and the second position; and
moving the phased array antenna to the selected position.

9. The method of claim 1, wherein the phased array antenna further comprises a plurality of antennas, and the method further comprises:
measuring a first amount of interference on the electromagnetic signal;
selecting a test antenna of the plurality of antennas;
disabling the test antenna;
measuring a second amount of interference on the electromagnetic signal; and
enabling the test antenna when the first amount of interference of the electromagnetic signal is less than or equal to the second amount of interference.

10. The method of claim 1, further comprising:
measuring a first amount of interference on the electromagnetic signal;
selecting a filter bank;
connecting the filter bank to the phased array antenna;
measuring a second amount of interference on the electromagnetic signal; and
disconnecting the filter bank when the first amount of interference is lower than the second amount of interference.

11. A phased array antenna system comprising:
a phased array antenna comprising a plurality of antenna configured to receive an electromagnetic signal having a signal frequency, a signal transmission period, a signal shape, and a signal interference;
a frequency controller connected to the phased array antenna and configured to adjust the signal frequency of the electromagnetic signal based on the signal interference;
a period controller connected to the phased array antenna and configured to adjust the signal transmission period of the electromagnetic signal to minimize the signal interference; and
a shape controller connected to the phased array antenna and configured to adjust the signal shape of the electromagnetic signal by selecting a taper from a collection of preset tapers.

12. The phased array antenna system of claim 11, wherein the shape controller is configured to select the taper based on an amount of interference of the electromagnetic signal.

13. The phased array antenna system of claim 11, wherein the shape controller is configured to select the taper based on a lost packet value.

14. The phased array antenna system of claim 11, wherein the frequency controller is configured to adjust the signal frequency based on an interference measurement received from a user terminal in communication with the frequency controller.

15. The phased array antenna system of claim 11, further comprising:
a filter bank controller connected to the phased array antenna; and
a plurality of filter banks connected to the filter bank controller and configured to filter the electromagnetic signal,
wherein the filter bank controller is configured to activate a filter bank of the plurality of filter banks to filter the electromagnetic signal based on the signal interference.

16. The phased array antenna system of claim 11, further comprising an antenna switch connected to at least one antenna of the plurality of antennas, wherein the antenna switch is configured to disconnect the at least one antenna in response to the signal interference.

17. The phased array antenna system of claim 11, wherein the period controller is configured to adjust the signal transmission period of the electromagnetic signal based on a time interference value received from a user terminal in communication with the period controller.

18. The phased array antenna system of claim 11, further comprising:
a rotator connected to the phased array antenna; and
a position controller connected to the rotator and configured to control the rotator to adjust a position of the phased array antenna in response to the signal interference.

19. The phased array antenna system of claim 11, wherein the shape controller is configured to select the taper from the collection of preset tapers on the signal interference.
